(19) United States
(12) Patent Application Publication
(10) Pub. No.: US 2013/0242552 A1
(43) Pub. Date: Sep. 19, 2013

(54) LED LIGHT DEVICE FOR PREVENTING GLARE

(71) Applicants: Jui Fong CHIEN, Hsinchu (TW); Ching Tzung Lin, Hsinchu (TW); Ta Yu Chen, Hsinchu (TW); Ri Feng Wang, Hsinchu (TW)

(72) Inventors: Jui Fong CHIEN, Hsinchu (TW); Ching Tzung Lin, Hsinchu (TW); Ta Yu Chen, Hsinchu (TW); Ri Feng Wang, Hsinchu (TW)

(21) Appl. No.: 13/423,308

(22) Filed: Mar. 19, 2012

(51) Int. Cl. F21V 1/04

(52) U.S. Cl. 362/235

(57) ABSTRACT

An LED light device includes a housing having a chamber formed by a base wall and an outer peripheral wall, a board attached to the base wall, a number of LED light members attached to the board, a hood attached to the base wall and engaged onto the board for covering the LED light members, and a shade engaged into the housing and having two end wall members, and a pair of plates coupled between the end wall members for forming a compartment and for engaging with the hood, and for preventing the glare from being generated and emitted out of the LED light device and for preventing the user from feeling dizzy and for preventing the eyes of the user from being tired or fatigued.

### BACKGROUND OF THE INVENTION

1. Field of the Invention

The present invention relates to an LED (Light Emitting Diode) light device, and more particularly to an LED light device including a structure for preventing the glare from being generated and emitted out of the LED light device and for preventing the user from feeling dizzy and for preventing the eyes of the user from being tired or fatigued.

2. Description of the Prior Art

Typical LED light assemblies or devices comprise a receptacle or housing for attaching or mounting or securing or engaged into a ceiling, and one or more circuit boards disposed or attached or mounted or secured in the housing and including a number of LED light members for generating lights with greatly reduced electric energy and cost.

For example, U.S. Pat. No. 7,645,052 to Villard, U.S. Pat. No. 7,690,809 to Tsai et al., U.S. Pat. No. 7,931,517 to Yang et al., and U.S. Pat. No. 7,954,975 to Zhou disclose several of the typical LED light assemblies or devices each also comprising a number of LED light members received or engaged in and attached or mounted or secured in an outer housing for attaching or mounting or securing or engaged into a ceiling, and for generating lights with less electric energy.

However, the LED light members are normally exposed and may generate and emit strong lights that the user may feel dizzy and that the eyes of the user may feel tired or fatigued after a short term of using.

The present invention has arisen to mitigate and/or obviate the afore-described disadvantages of the conventional LED light devices.

### SUMMARY OF THE INVENTION

The primary objective of the present invention is to provide an LED light device including a structure for preventing the glare from being generated and emitted out of the LED light device and for preventing the user from feeling dizzy and for preventing the eyes of the user from being tired or fatigued.

In accordance with one aspect of the invention, there is provided an LED light device comprising a housing including a chamber formed therein and defined by a base wall and an outer peripheral wall, a board disposed in the chamber of the housing and attached to the base wall of the housing, a number of LED light members attached to the board, a hood attached to the base wall of the housing and engaged onto the board for covering and shielding the LED light members, and a shade engaged into the chamber of the housing and including two end wall members, and a pair of plates coupled between the end wall members for forming a compartment and for receiving and engaging with the hood, and arranged for allowing the hood to be engaged in the compartment of the shade.

The housing includes a pair of anchors attached to the base wall of the housing and disposed on opposite sides of the board for anchoring and retaining the hood to the base wall of the housing. The anchors each include a space formed by a flap for engaging with the hood.

The hood includes two opposite side portions each having a catch extended therefrom for engaging with the spaces and the flaps of the anchors and for detachably anchoring and retaining the hood to the housing.

The shade includes an opening formed in each of the end wall members for receiving and engaging with end portions of the hood. The hood includes a length shorter than a width of the base wall of the housing for forming two gaps between the end portions of the hood and the outer peripheral wall of the housing.

The shade includes a flange extended from each of the end wall members for engaging with the outer peripheral wall of the housing and for covering and blocking the gaps that are formed between the end portions of the hood and the outer peripheral wall of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an LED light device in accordance with the present invention;

FIG. 2 is a partial exploded view of the LED light device;

FIG. 3 is a partial perspective view of the LED light device, in which a portion of the light device has been cut off or removed for showing the inner structure of the light device;

FIGS. 4, 5 are cross sectional views of the LED light device, taken along lines 4-4, and 5-5 of FIG. 1 respectively; and

FIGS. 6, 7 are enlarged partial cross sectional views of the LED light device, illustrating the assembling operation of the LED light device.

### DETAILED DESCRIPTION OF THE PREFERRED EMBODIMENT

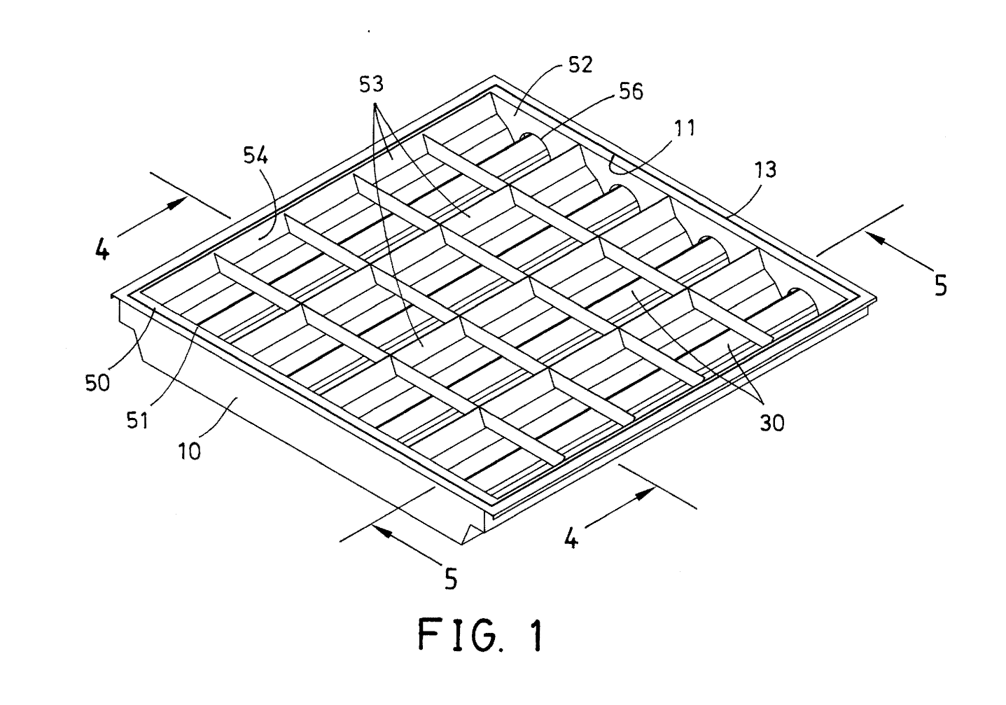

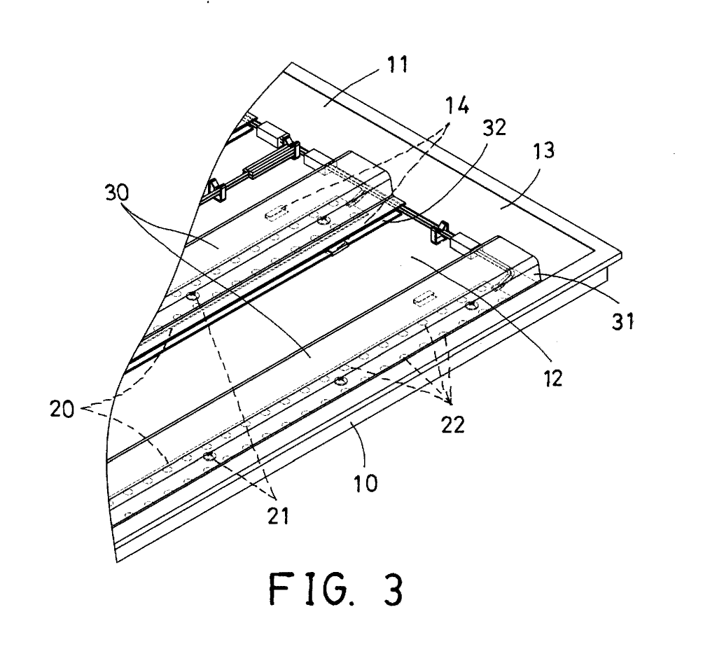

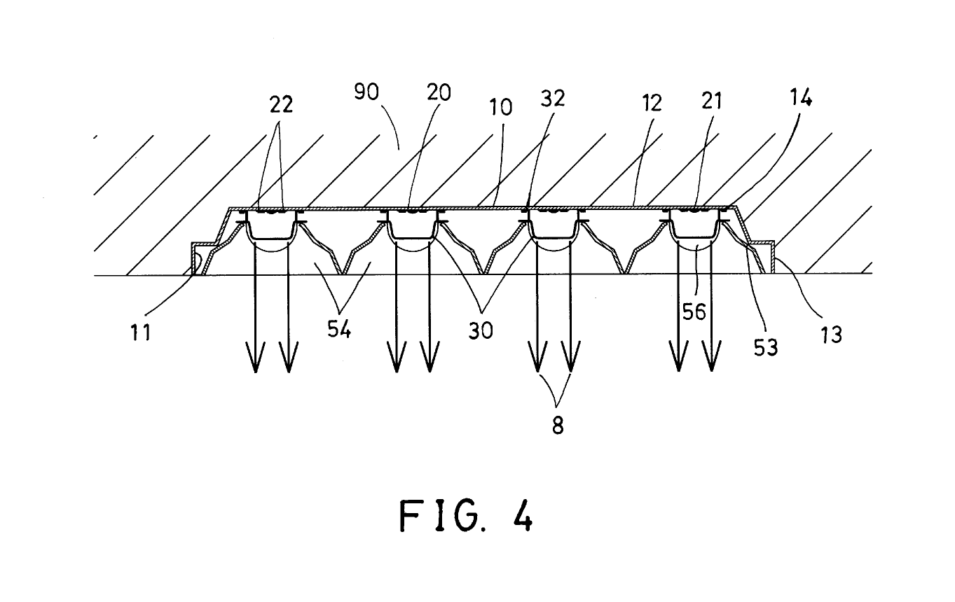

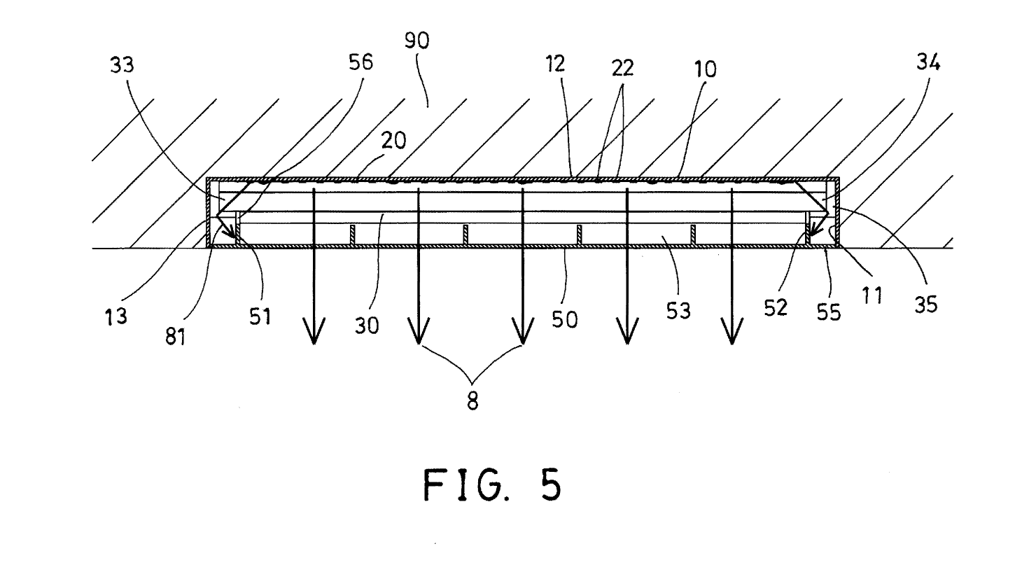

Referring to the drawings, and initially to FIGS. 1-5, an LED light device in accordance with the present invention comprises an outer receptacle or housing 10 for attaching or mounting or securing or engaged into a ceiling 90 (FIGS. 4, 5), and the housing 10 includes a chamber 11 formed therein and formed or defined by a upper or base wall 12 and/or an outer peripheral wall 13, it is to be noted that the housing 10 is shown up-side-down in FIGS. 1-3 and 6-7, such that the upper or base wall 12 is shown in the lower or bottom portion of the housing 10 in FIGS. 1-3, but shown in the upper portion of the housing 10 in FIGS. 4 and 5.

One or more circuit boards 20 are disposed or received or engaged in the chamber 11 of the housing 10 and attached or mounted or secured to the base wall 12 of the housing 10 with one or more latches or fasteners 21, a number of LED light members 22 are attached or mounted or secured to the circuit boards 20 and preferably arranged in series or in lines, and a transformer or battery or power supply device 23 is also attached or mounted or secured to the base wall 12 of the housing 10 and electrically connected or coupled to the LED light members 22 for energizing or actuating the LED light members 22 to generate and emit lights 8 (FIGS. 4, 5) with greatly reduced electric energy and cost.

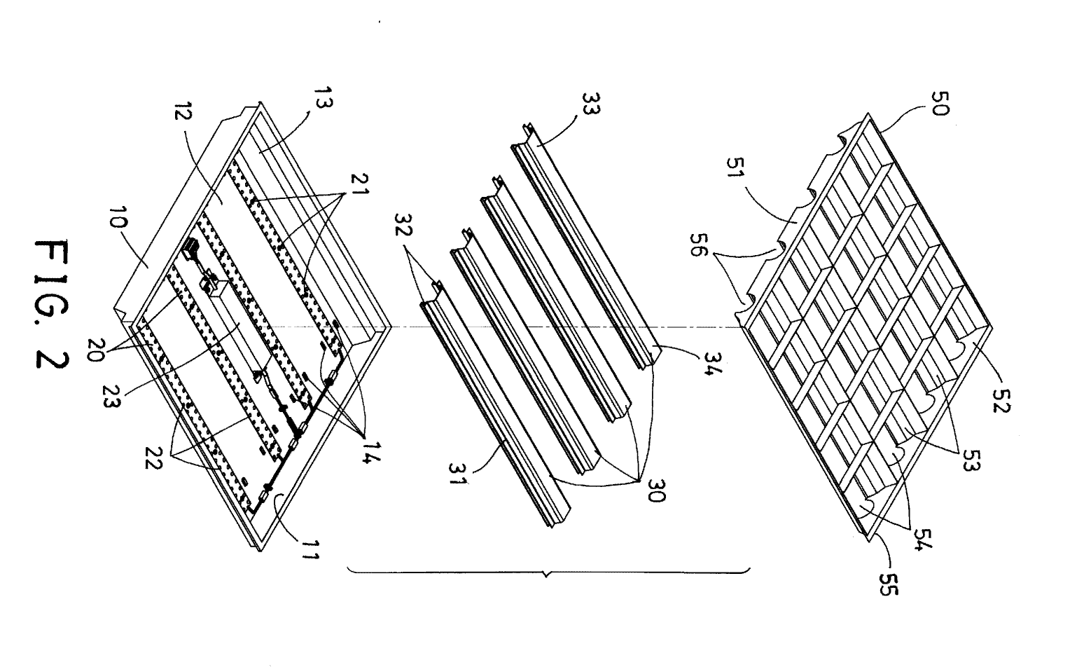

The housing 10 further includes one or more pairs of latches or anchors 14 disposed or attached or mounted or arranged on opposite sides of the circuit boards 20, best shown in FIGS. 2-4 and 6-7 for attaching or mounting or securing or anchoring or retaining one or more shields or hoods 30 to the base wall 12 of the housing 10, in which one hood 30 is to be provided and attached or mounted or engaged onto each of the circuit boards 20 for covering or shielding the LED light members 22 and/or for filtering the lights 8 and for preventing the glare from being generated and emitted out through the hoods 30 and for preventing the user from feeling dizzy and for preventing the eyes of the user from being tired or fatigued.

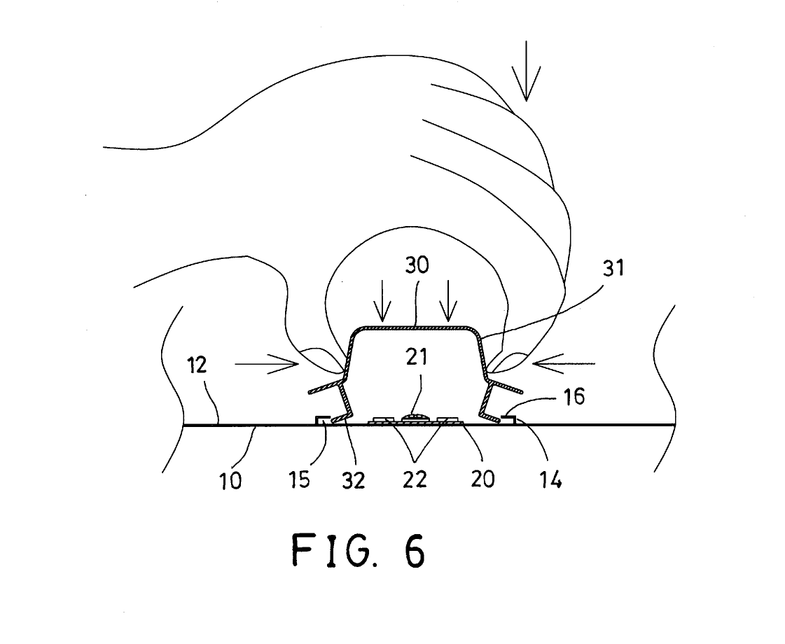

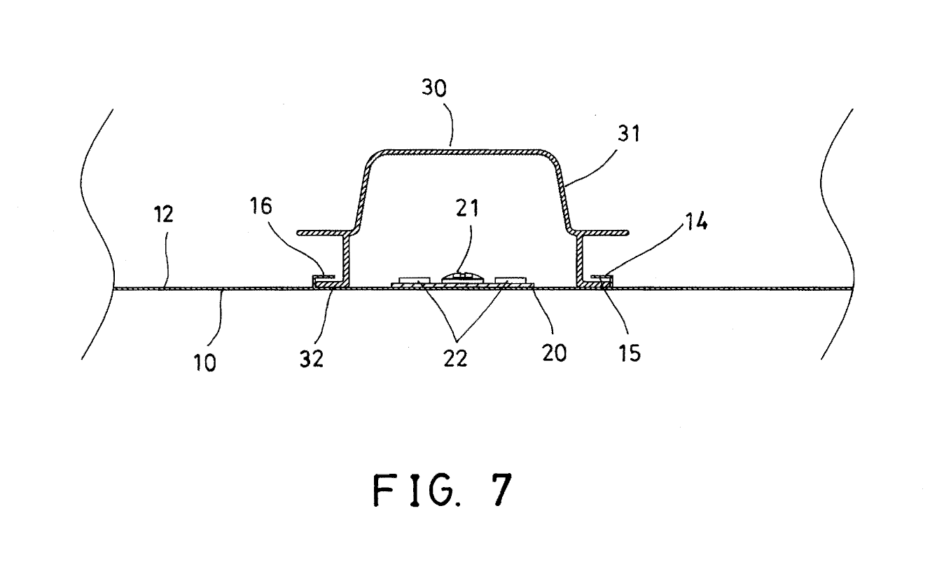

For example, as best shown in FIGS. 6-7, the anchors 14 each include an L-shaped structure having a channel or space 15 formed or defined by an elevated flange or flap 16 which is spaced from or disengaged from and parallel to the base wall 12 of the housing 10, and the spaces 15 of the anchors 14 are directed or faced toward each other. The hoods 30 each include a substantially C or inverted U-shaped structure having two opposite side portions 31, and a leg or rim or rib or catch 32 extended radially and outwardly from each of the side portions 31 of the hood 30 for selectively engaging with the spaces 15 of the anchors 14 and for detachably attaching or mounting or securing or anchoring or retaining the hood 30 to the base wall 12 of the housing 10.

It is to be noted that the C or inverted U-shaped structure of the hood 30 allows the side portions 31 of the hood 30 to be easily depressed or moved or forced toward each other (FIG. 6), and thus for allowing the catches 32 of the hood 30 to be easily and quickly and readily moved or disengaged from the anchors 14, and for allowing the catches 32 of the hood 30 to be easily engaged into the spaces 15 of the anchors 14 (FIG. 7) by the resilience or spring force of the side portions 31 of the hood 30. It is preferable, but not necessarily that the hood 30 includes two end portions 33, 34 (FIGS. 2, 5) and includes a length slightly shorter than the width of the base wall 12 of the housing 10 for forming two end spaces or gaps 35 (FIG. 5) between the end portions 33, 34 of the hood 30 and the outer peripheral wall 13 of the housing 10.

A shield or shade 50 is to be disposed or engaged into the chamber 11 of the housing 10 and to be attached or mounted or secured to the housing 10 with one or more latches or fasteners (not shown), or welders or adhesive members, and includes two end wall members 51, 52, and one or more pairs of refractive or reflective plates 53 attached or mounted or secured or coupled between the end wall members 51, 52 for forming or defining one or more compartments 54 and for receiving or engaging with the hoods 30, and arranged for allowing the hoods 30 to be disposed or engaged in the compartments 54 of the shade 50 respectively, best shown in FIG. 4, and for allowing the lights 8 generated and emitted from the LED light members 22 to be refracted or reflected by the refractive or reflective plates 53.

The end wall members 51, 52 each include a flap or rib or flange 55 extended outwardly therefrom (FIGS. 2, 5) for engaging with the outer peripheral wall 13 of the housing 10 (FIG. 5) and for covering or shielding or blocking the gaps 35 that are formed between the end portions 33, 34 of the hood 30 and the outer peripheral wall 13 of the housing 10. The shade 50 further include one or more openings 56 formed in each of the end wall members 51, 52 thereof for receiving or engaging with the end portions 33, 34 of the hood 30 and for solidly and stably anchoring or securing or positioning or retaining the hoods 30 between the housing 10 and the shade 50.

As best shown in FIG. 5, a portion of the light 81 generated and emitted from the LED light members 22 may be emitted into the gaps 35 that are formed between the end portions 33, 34 of the hood 30 and the outer peripheral wall 13 of the housing 10, but may be blocked or covered or shielded by the end wall members 51, 52 of the shade 50 and/or the flanges 55 of the end wall members 51, 52 of the shade 50, for preventing the light 81 from being generated and emitted out of the shade 50, and for preventing the user from feeling dizzy and for preventing the eyes of the user from being tired or fatigued by the lights 8, 81 generated by the LED light members 22.

Accordingly, the LED light device in accordance with the present invention includes a structure for preventing the glare from being generated and emitted out of the LED light device and for preventing the user from feeling dizzy and for preventing the eyes of the user from being tired or fatigued.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An LED light device comprising:
a housing including a chamber formed therein and defined by a base wall and an outer peripheral wall,
a board disposed in said chamber of said housing and attached to said base wall of said housing,
a plurality of LED light members attached to said board,
a hood attached to said base wall of said housing and engaged onto said board for covering and shielding said LED light members, and
a shade engaged into said chamber of said housing and including two end wall members, and a pair of plates coupled between said end wall members for forming a compartment and for receiving and engaging with said hood, and arranged for allowing said hood to be engaged in said compartment of said shade.

2. The LED light device as claimed in claim 1, wherein said housing includes a pair of anchors attached to said base wall of said housing and disposed on opposite sides of said board for anchoring and retaining said hood to said base wall of said housing.

3. The LED light device as claimed in claim 2, wherein said anchors each include a space formed by a flap for engaging with said hood.

4. The LED light device as claimed in claim 3, wherein said hood includes two opposite side portions each having a catch extended therefrom for engaging with said spaces and said flaps of said anchors and for detachably anchoring and retaining said hood to said housing.

5. The LED light device as claimed in claim 1, wherein said shade includes an opening formed in each of said end wall members for receiving and engaging with end portions of said hood.

6. The LED light device as claimed in claim 5, wherein said hood includes a length shorter than a width of said base wall of said housing for forming two gaps between said end portions of said hood and said outer peripheral wall of said housing.

7. The LED light device as claimed in claim 6, wherein said shade includes a flange extended from each of said end wall members for engaging with said outer peripheral wall of said housing and for covering and blocking said gaps that are formed between said end portions of said hood and said outer peripheral wall of said housing.
